(19) United States
(12) Patent Application Publication
(10) Pub. No.: US 2010/0251114 A1
(43) Pub. Date: Sep. 30, 2010

(54) DIGITAL INTERFACE FOR A MEDICAL DEVICE

(75) Inventors: Steven R. Wehba, Carlsbad, CA (US); Mihaela Cozmi, Gilroy, CA (US); Sharon K. Jackson, Deerfield, IL (US); Martin J. King, San Diego, CA (US); Paul Lindstrom, Gurnee, IL (US); H. Clay Teel, IV, San Diego, CA (US)

Correspondence Address: BRIAN R. WOODWORTH, 275 N. FIELD DRIVE, DEPT. NLEG BLDG H-1, LAKE FOREST, IL, 60045-2579, US

(73) Assignee: HOSPIRA, INC., Lake Forest, IL (US)

(21) Appl. No.: 12/749,651

(22) Filed: Mar. 30, 2010

Related U.S. Application Data
(60) Provisional application No. 61/165,066, filed on Mar. 31, 2009.

(51) Int. Cl. G06F 3/048; G06F 3/01

(52) U.S. Cl. 715/702; 715/786; 715/830

(57) ABSTRACT

A digital interface has a main screen having a treatment screen and a scroll bar. The treatment screen includes a list of treatment inputs. The scroll bar has a displacement detection area, and the scroll bar scrolls to a divider in the list of treatment inputs in response to movement along the displacement detection area. The treatment screen displays the list of treatment inputs beginning with the divider.

### BACKGROUND OF THE INVENTION

This invention relates to a means and method for a digital interface. More specifically, this invention relates to an interface for medical devices, including infusion systems and pumps, which provides a user with the capability to search for, access, and input information more quickly and reliably.

Medical devices that monitor the status of a patient's health, administer treatments including drugs, fluids, or nutrients, or provide other various diagnostic, rehabilitative, or life sustaining roles have long been controlled electronically. Whether utilized at a hospital, out-patient clinic, or remotely in the home or as a portable device, a vast majority of electronically controlled medical devices are provided with some type of digital user interface which allows a user or health care professional to control the operation of the device in a variety of ways. As technology advances, electronics used in the medical field are not only becoming more versatile, medical electronics are also becoming more functionally advanced in terms of the amount of information that can be stored and the number of programming platforms that can be supported.

The increases in versatility and functionality have also confronted users of medical devices with unique challenges; because many medical electronics are characterized by advanced programming, significant information storage capacity, and the ability to be utilized for a variety of applications, current user interfaces utilized by many medical devices pose a variety of problems. Often times a medical device having advanced programming and the ability to transition between multiple applications is accompanied by a complex user interface that is difficult and time consuming to navigate. Furthermore, an increased information storage capacity will typically be utilized to store as much information as possible, and as a result, an individual attempting to program or operate the device will be confronted with a significant amount of information in attempting to access a desired entry. This is of particular concern with medical devices which can be programmed to administer various drugs. Often such devices contain drug libraries or other lists that may include the names of hundreds or thousands of drugs, fluids, nutrients, etc. Such lists not only can result in a significant amount of wasted time as a user is attempting to locate a particular drug out of chances of drug misspelling and misidentification increase.

Therefore, it is a principal object of this invention to provide a programming interface for medical devices which provides a user with the capability to search for, access, and input information more quickly.

A further object of the present invention is to provide a programming interface for medical devices that allows a user to efficiently sort through a long list of items and display a subset thereof.

Yet another object of the present invention is to provide a programming interface for medical devices which provides a user with the capability to search for, access, and input information more reliably.

A further object of the present invention is to provide a programming interface for medical devices which reduces the incidence of user mistakes and promotes safety.

Yet another object of the present invention is to provide a programming interface that allows a user to more quickly access, select, and input an entry from a list of drugs into a relevant field of an infusion pump.

These and other objects, features or advantages of the present invention will become apparent from the specification and claims.

### BRIEF SUMMARY OF THE INVENTION

The present invention relates to a digital interface with a main screen having a treatment screen and a scroll bar, with the treatment screen including a list of treatment inputs. The scroll bar has a displacement detection area, and the scroll bar scrolls to a divider in the list of treatment inputs in response to movement along the displacement detection area. The treatment screen displays the list of treatment inputs beginning with the divider.

In another embodiment of the invention, the digital interface has an alphabetic or alpha-numeric keypad and displays a plurality of sequential entry positions. In order to locate and display a particular desired treatment input, the user enters in at least two alphabetical or alpha-numeric characters into at least the first and second entry positions before various treatment inputs beginning with those two characters are displayed. In one embodiment, three character and corresponding entry positions must be filled before the corresponding treatment inputs are displayed.

In another embodiment, a scroll bar is substituted for the keypad discussed in the paragraph above.

### BRIEF DESCRIPTION OF THE DRAWINGS

FIG. 1 is a screen shot of a digital interface according to one embodiment of the present invention;

FIG. 2 is another screen shot of a digital interface according to the embodiment of FIG. 1;

FIG. 3 is another screen shot of a digital interface according to the embodiment of FIG. 1;

FIG. 4 is another screen shot of a digital interface according to the embodiment of FIG. 1;

FIG. 5 is a partial screen shot exhibiting an alternate embodiment of the present invention; and

FIG. 5A is a partial screen shot exhibiting another alternate embodiment of the present invention.

FIG. 5B is a partial screen shot exhibiting another alternate embodiment of the present invention.

FIG. 5C is a partial screen shot exhibiting another alternate embodiment of the present invention.

### DETAILED DESCRIPTION OF THE PREFERRED EMBODIMENT

Referring to the figures, a digital interface 10 is included to program, operate, and monitor a medical device. As will be appreciated by one of ordinary skill in the art, a digital interface 10 can be utilized in many different types of devices including any medical device that electronically monitors the status of a patient's health, administers treatments including drugs, fluids, or nutrients, or provides other various diagnostic, rehabilitative, or life sustaining roles. One of ordinary skill in the art will appreciate that whatever particular electronic medical device that incorporates digital interface 10 can include features (not shown in the drawings) such as a central processing unit, RAM, microprocessors, and various other electronic and computational functionally as is known in the art. Digital interface 10, in one embodiment of the invention, is incorporated into a medical pump or infusion device (not shown) with one or more output lines (not shown) and one or more input lines (not shown). The digital interface 10 is actuated by touch screen in one embodiment of the invention. However, those of ordinary skill in the art will appreciate that digital interface 10 can be actuated by a mouse, a stylus, or any other suitable known means. Digital interface 10 includes a plurality of pump line identifiers 12. In one embodiment, the pump line identifiers 12 provide information describing the pump line, including but not limited to the type of medication, drug, or treatment that is being administered by the pump line, the concentration of the medication/drug/treatment, the administration rate, and any other descriptive information regarding the therapy protocol applied to the treatment. Furthermore, in one embodiment, each pump line identifier 12 includes a main screen interface 14, described below, wherein by selecting a particular pump screen identifier 12 via the digital interface 10 by any means described herein and accessing its corresponding main screen interface 14, the user can program the operation of each specific pump line (not shown).

Digital interface 10 also includes, in one embodiment, a Clinical Care Area (CCA) identifier 16. The CCA identifier 16 identifies the Clinical Care Area in which the medical device is being utilized, and as appreciated by one skilled in the art, digital interface 10 can be programmed to operate differently depending upon which CCA identifier 16 is selected. A plurality of utility activation points 18 or “buttons” are also included in the digital interface 10. Utility activation points 18 include but are not limited to mode 20, tools 22, tasks 24, lock 26, and alarm 28.

A main screen interface 14 is also included in the digital interface 10. In one embodiment of the invention, the main screen interface 14 includes a treatment display 30, a program display 32, a confirmation display 34, and an options display 36, all of which present a user with a different main screen interface 14 display depending upon which individual display is activated. The treatment display 30 screen includes a treatment input list 38. The treatment input list 38 contains various treatment inputs 40, including but not limited to drug names, medications, and any other substance known in the art to be utilized for medical purposes, such as saline solution, vitamins, nutrients, etc. Each individual treatment input 40 included on the treatment input list 38 can be selected by the user by any means disclosed herein. In one embodiment of the present invention, the treatment display 30 screen displays the treatment input list 38 as a single column of treatment inputs 40; however, in other embodiments the treatment inputs 40 are displayed in two or more columns, rows, loops or other formats within the treatment input list 38, as appreciated by those skilled in the art.

The treatment display 30 includes a plurality of treatment display programming selections 42, which are used to customize the manner in which the treatment input list 38 is populated and displayed. One treatment display programming selection 42 is the “all” selection 44, which populates the treatment input list 38 with the complete collection of the treatment inputs 40 available. Another treatment display programming selection 42 is the “common” selection 46, which populates the treatment input list 38 with a collection of the most frequently used treatment inputs 40. Those having skill in the art will recognize that a variety of options are available to implement the functionalities of the treatment display programming selections 42. The “recent” selection 48 is yet another treatment display programming selection 42, which populates the treatment input list 38 with a collection of the treatment inputs 40 that have been used recently. The “orders” treatment programming selection 50 allows only those treatment inputs 40 that correspond to a patient's treatment orders to be included in the treatment input list 38. Finally, the protocols programming selection 52 populates the treatment library with programs which pre-select a particular drug, medication, or treatment to be administered (treatment input 40), in addition to the rate and volume that the treatment input 40 is to be administered, wherein each protocol 52 is specific to the treatment of a particular condition, such as breast cancer.

In one embodiment of the present invention, the treatment input list 38, whether displayed in its entirety or according to a treatment display programming selection 42, is alphabetized and sorted such that the treatment inputs 40 are grouped according to their first letter. After the groups of treatment inputs 40 beginning with the same letter are grouped within the treatment input list 38, a divider 54 is associated with each group of treatment inputs 40 beginning with the same letter. In one embodiment of the invention, each divider 54 is inserted into the treatment input list 38 and displayed such that dividers 54 separate successive alphabetized groups of treatment inputs 40 beginning with the same letter; e.g., a divider 54, displayed as “—D—,” separates the last treatment input 40 beginning with a “C” from the first treatment input 40 beginning with a “D.”

The treatment display 30 also includes a scroll bar 56 adjacent to the treatment input list 38, wherein actuation of the scroll bar 56 allows the user to navigate through the treatment input list 38 and, in one embodiment, select which treatment inputs 40 are displayed on the treatment display 30 screen. The scroll bar 56 includes a displacement detection area 58 which detects movement from a user wherein user input is translated into scroll bar 56 movement. The scroll bar 56 is linked to the treatment input list 38 such that actuation or movement of the scroll bar 56 causes the treatment display 30 to cycle through the treatment input list 38 in a corresponding manner, e.g., wherein the scroll bar 56 is vertically oriented, movement in an upward direction detected in the displacement detection area 58 causes the treatment input list 38 to cycle upward toward the beginning of the alphabet, and another embodiment having a horizontal scroll bar 56, movement in a rightward motion detected in the displacement detection area 58 causes the treatment input list 38 to cycle rightward toward the end of the alphabet. Control of the scroll bar 56, in one embodiment, is by touch screen, wherein the displacement detection area 58 detects tactile and spatial touch such that a user actuates the scroll bar 56 by touching and dragging their finger on the displacement detection area 58. However, those of ordinary skill in the art will appreciate that digital interface 10 can be actuated by a mouse, a stylus, or any other suitable known means. In yet another embodiment, the scroll bar 56 includes a slider 60 that moves along the displacement detection area 58 in a manner consistent with user actuation of the scroll bar 56 and indicates the position of the scroll bar 56 relative to the treatment input list 38. In addition, another embodiment includes directional buttons 62 at terminal ends of the displacement detection area 58 which advance the scroll bar 56 in a direction corresponding to the position of the directional buttons 62.

The scroll bar 56 scrolls to positions defined by letters of the alphabet, wherein each position of the alphabet corresponds with a divider 54 which is itself associated with each group of treatment inputs 40 beginning with the same letter. In this manner, when the scroll bar 56 scrolls to a divider 54 in the treatment input list 38, a subset of the treatment inputs 40 are displayed which, beginning with the associated divider 54, all begin with the same letter.

The treatment display 30 also includes an emergency activation point, or STAT 64, which can be activated in an emergency situation when a patient is crashing or going to code. Activation of the STAT 64 activation point allows the user to input the rate 80 (described below) of treatment administration without specifically selecting the treatment input 40 in order to more quickly administer life saving treatment or medication.

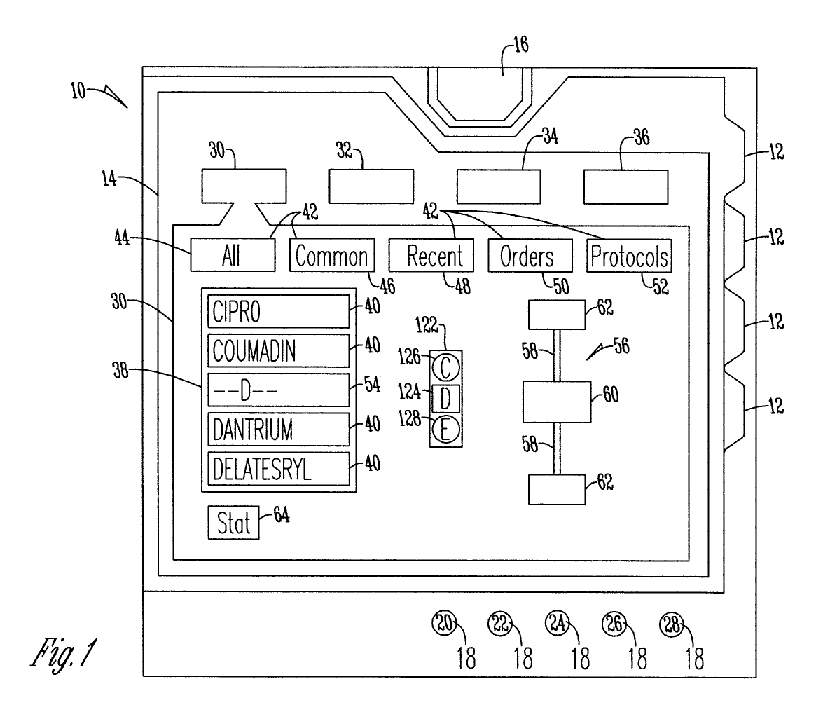

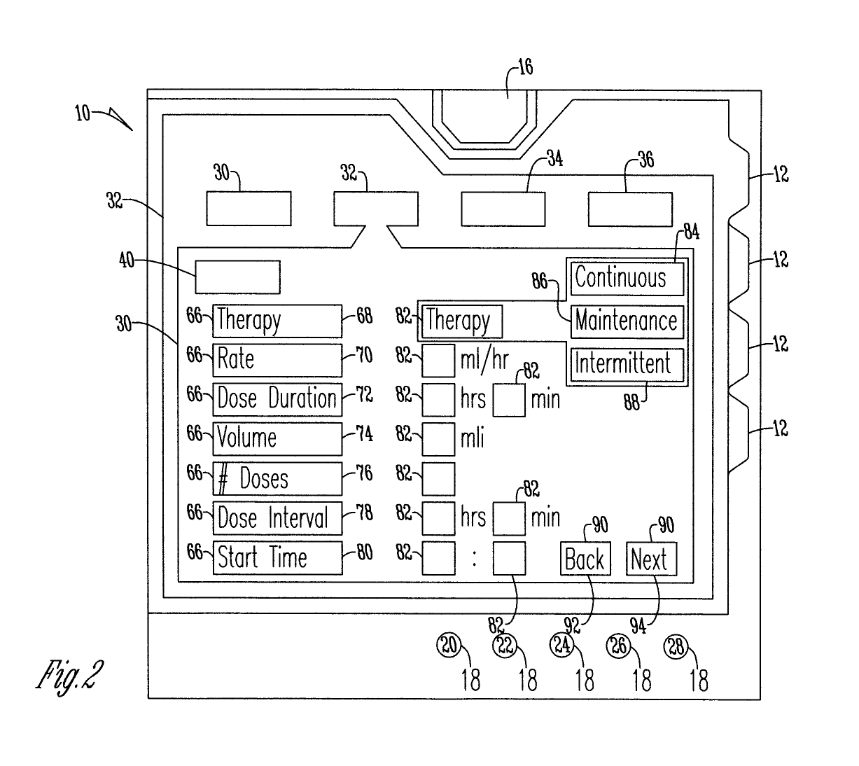

As best seen in FIGS. 1 and 2, the main screen interface 14 also includes a program display 32, which displays the treatment input 40 selected in the treatment display 30 and contains a plurality of treatment administration inputs 66 which allows the user to program the manner in which the treatment input 40 (drug/medication/vitamin solution/saline drip/etc) is administered. The treatment administration inputs 66 include but are not limited to therapy 68, rate 70, dose duration 72, volume 74, number (#) of doses 76, dose interval 78, and start time 80. In one embodiment of the invention, a user can set each treatment administration input 66 by selecting a field input access point 82 associated with each individual treatment administration input 66 by touch screen, or any other means known in the art. Selecting the therapy 68 field input access point 82 allows a user to select between continuous 84 administration of therapy, maintenance 86 therapy administration, or administration of therapy on an intermittent 88 basis. The continuous 84, maintenance 86, and intermittent 88 therapy 68 options are presented as touch screen selections displayed in a pop up screen juxtapositioned over the program display 32 screen near the therapy 68 field input access point 82. The rate 70 of administration of treatment can be set by selecting the associated field input access point 82, wherein, in one embodiment, a pop up keypad appears overlaying the program display 32 screen highlighting the rate 70 field input access point 82 which allows the user to input the appropriate rate 70 of treatment administration in mL/hr, or any other appropriate rate denomination as known in the art. The dose duration 72, volume 74, # doses 76, dose interval 78, and start time 80 are programmed in a corresponding fashion, wherein upon selection of the field input access point 82 associated with each treatment administration input 66, a pop up keypad appears juxtapositioned over the program display 32 screen near each field input access point 82 which allows the user to input the time period in hours/minutes of dose duration 72, the volume 74 in mL or other suitable units, the number of doses for # doses 76, the dose interval in hours/minutes for the dose interval 78 input, and the start time 80. As appreciated by those skilled in the art, various treatment protocols may not require a user to input a selection for every treatment administration input 66, while still others may require additional treatment administration inputs 66 depending upon the particular treatment required.

The program display 32, in one embodiment, includes a plurality of user navigation points 90 which can be selected by the user to return to the screen the user had previously accessed or advance to a successive screen that had been accessed and navigated away from or when a series of screens are designed to be incrementally navigated in a pre-defined sequence. One example of user navigation points 90 includes a back 92 and next 94 navigation point, whereupon selection of the back 92 point, via touch screen or any other means known in the art, returns a user to a previous screen, and selection of the next 94 point, in a like manner, navigates the user to a successive screen as disclosed above. As appreciated by one skilled in the art, the back 92 and next 94 navigation points can be represented by arrows, words, or icons that indicate directional navigation. Alternatively, the plurality of navigation points 90 are included in each display screen of the main screen interface 14, allowing the user to navigate to prior and successive screens at any point during use of the digital interface 10.

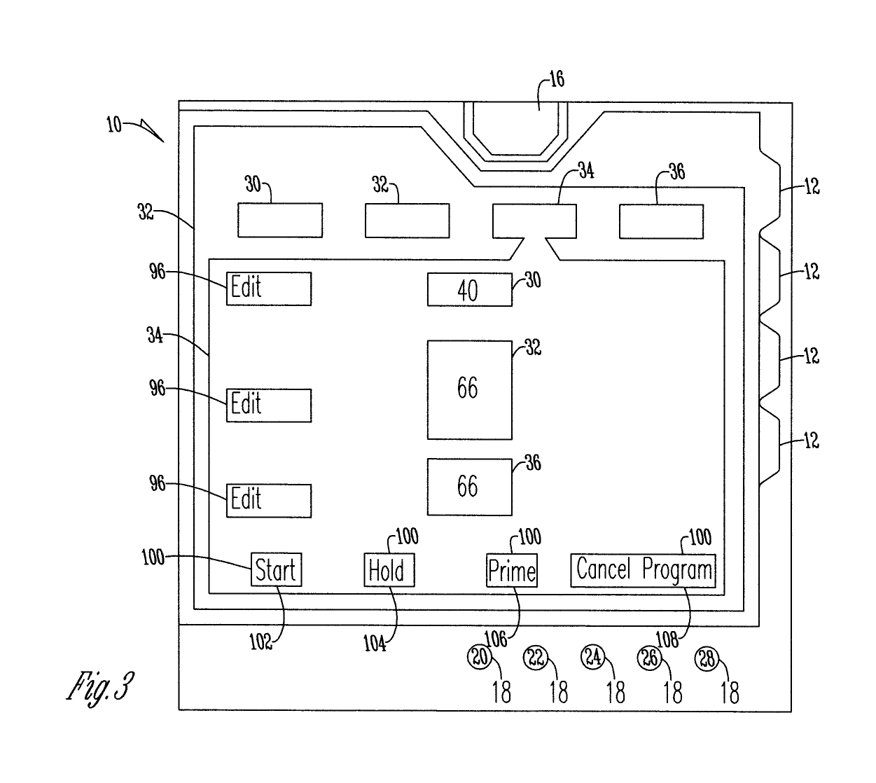

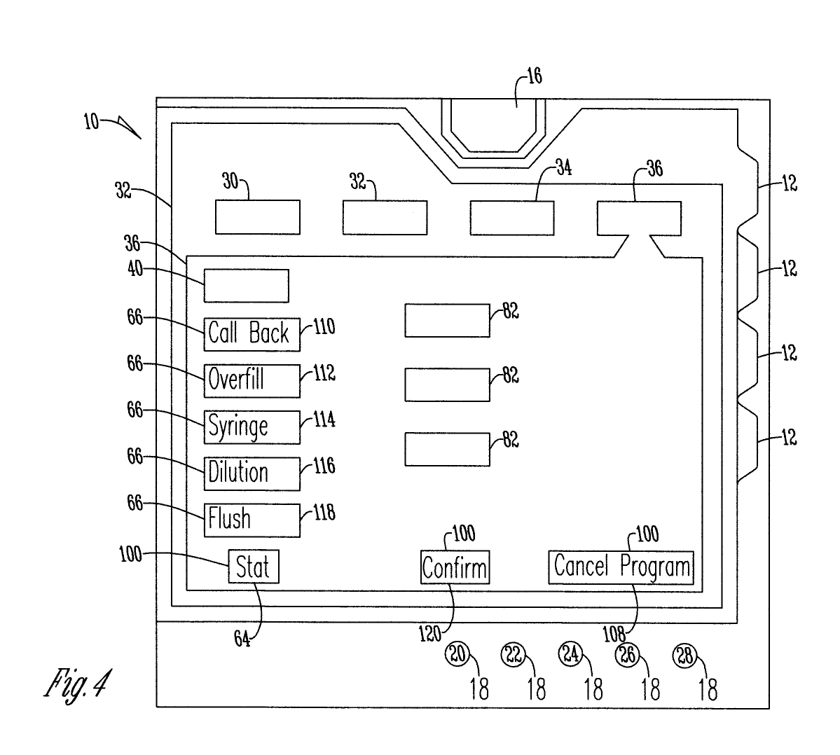

As best understood in view of FIGS. 1-3, also included in the main screen interface 14 is the confirm display 34 screen, which displays the treatment input 40 selected in the treatment display 30, the treatment administration inputs 66 set in the program display 32, treatment administration inputs 66 set in the options display 36 (described below with respect to FIG. 4), wherein the entries selected from each separate display screen are grouped and accompanied by an edit 96 activation point. Selection of the edit 96 activation point allows the user to edit the entries and programming options originally selected in each separate display screen. For example, selecting the edit 96 activation point adjacent to the treatment input 40, the treatment administration inputs 66, and/or the treatment administration inputs 66 set in the options display 36 allows a user to return to the treatment display 30, program display 32, or options display 36, respectively, to adjust, change, or update any previously entered selection to correct an error or account for a change in circumstances. The confirm display screen 34 (FIG. 3) further provides the user with access to device operation inputs 100, which include but are not limited to start 102, which signals the medical device to initiate treatment according to the inputs entered by the user, as described above, hold 104, which suspends initiation of the device while retaining the programming information entered, prime 106, which signals the device to perform a priming operation, and a cancel program 108 input that cancels the treatment program entered by the user and/or initiated by the device.

As best understood in view of FIGS. 1 and 4, the main screen interface 14 also features an options display 36. The options display 36 both displays the treatment input 40 selected in the treatment display 30 and presents the user with additional treatment administration inputs 66 and device operation inputs 100. The additional treatment administration inputs 66 provided in the options display 36 include caregiver call back 110, overfill 112, and syringe 114, which are accessed and adjusted by a user by utilizing field input access points 82 as described above. In addition to STAT 64 and cancel program 108, further device operation inputs 100 provided in the options display 36 include dilution 116, flush 118, and confirm 120, which, upon selection by touch screen or other means disclosed, respectively trigger dilution of the treatment selected, flush the lines of the device, and confirm any selections made in the options display screen 36, returning the user to the confirm display 34 screen to initiate the programming selections entered, if desired.

In operation, a user selects a pump line identifier 12 corresponding to the particular pump line that is to be programmed by touching a particular pump line identifier 12 displayed on the touch screen digital interface 10. The main screen interface 14 corresponding to the selected pump line identifier then appears on the digital interface 10, presenting the user with the treatment display 30 of FIG. 1. The user is presented with treatment display programming selections 42, wherein the treatment input list 38 is populated with treatment inputs 40 based upon the particular treatment display programming selection 42 accessed by the user, as described above. The treatment inputs 40 are then alphabetized and sorted according to the leading character of the treatment input 40 such that treatment inputs 40 sharing the same leading alphabetical letter, number, or symbol are separated into discrete groups within the treatment input list 38. The groups of treatment inputs 40 are then further alphabetized according to their subsequent characters, and a divider 54 is associated with each group of treatment inputs sharing the same leading letter, number, or symbol wherein the divider 54 is displayed as a letter, number, or symbol corresponding to the group of treatment inputs 40 the divider 54 identifies. In one embodiment, each divider 54 is inserted into the treatment input list 38 and displayed such that dividers 54 separate successive alphabetized groups of treatment inputs 40 beginning with the same letter, number, or symbol, and a subset of the treatment inputs 40 is displayed.

In one embodiment of the invention, scroll bar 56 is used to navigate the treatment input list 38 to search for, access, and input a particular treatment input 40. In order to actuate the scroll bar 56, a user touches the displacement detection area 58 of the scroll bar 56, displayed on the digital interface 10 which includes touch and pressure sensing capabilities, and drags or slides their finger along the displacement detection area 58 in the direction the user wishes the treatment input list 38 to advance. As the user's finger advances along the displacement detection area 58, the scroll bar 56 scrolls between positions defined by letters in the alphabet (in addition to numbers and symbols appearing in the treatment input list). In one embodiment, the letters, numbers, and symbols which define the positions of scroll bar 56 navigation are linked to a corresponding divider 54 wherein the treatment input list 38 displays the group of treatment inputs 40 that correspond to the alphabetical position of the scroll bar and the divider 54 and a subset of the treatment inputs 40 is displayed. Once the user scrolls to an appropriate alphabetical, numerical, or symbol position corresponding to the desired treatment input 40, the user stops any advancement along the displacement detection area 58 and releases their finger from the scroll bar 56 displayed on the digital interface 10. As appreciated by those skilled in the art, the scroll bar can additionally be actuated by any means known, including but not limited to tapping or applying pressure to the displacement detection area 58 of the scroll bar 56 once the appropriate position is reached. At this point, the treatment input list 38 is displaying the treatment inputs 40 which begin with the desired letter, number, symbol, etc. as a subset of all available treatment inputs 40, and the user can once again actuate the scroll bar 56 to locate the particular desired treatment input 40 within the displayed group of treatment inputs 40. Once the desired treatment input 40 is located within the treatment input list 38, the user can select and input the treatment input 40 by touching the particular input 40 displayed on the touch screen digital interface 10.

In one embodiment of the invention, the scroll bar 56 is accompanied by a three position window 122, wherein the three position window 122 displays a current position 124 of the scroll bar 56, a position preceding 126 the current position 124 of the scroll bar 56, and the position following 128 the current position 124 of the scroll bar 56. In one embodiment, the current position 124, the preceding position 126, and the position following 128 are each depicted as an appropriate alphabetical or alpha-numeric divider 54.

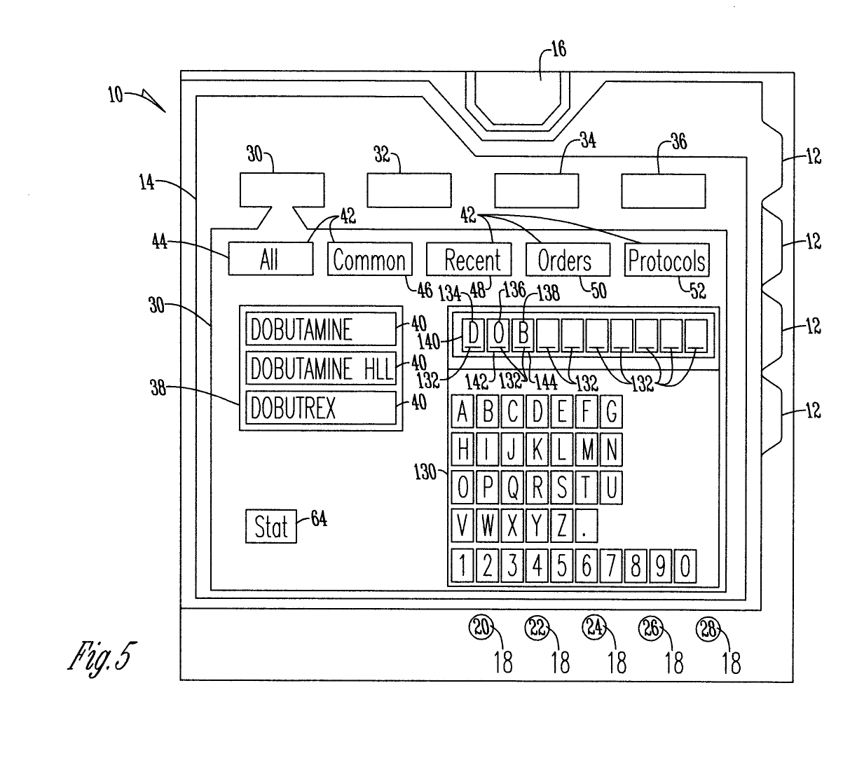

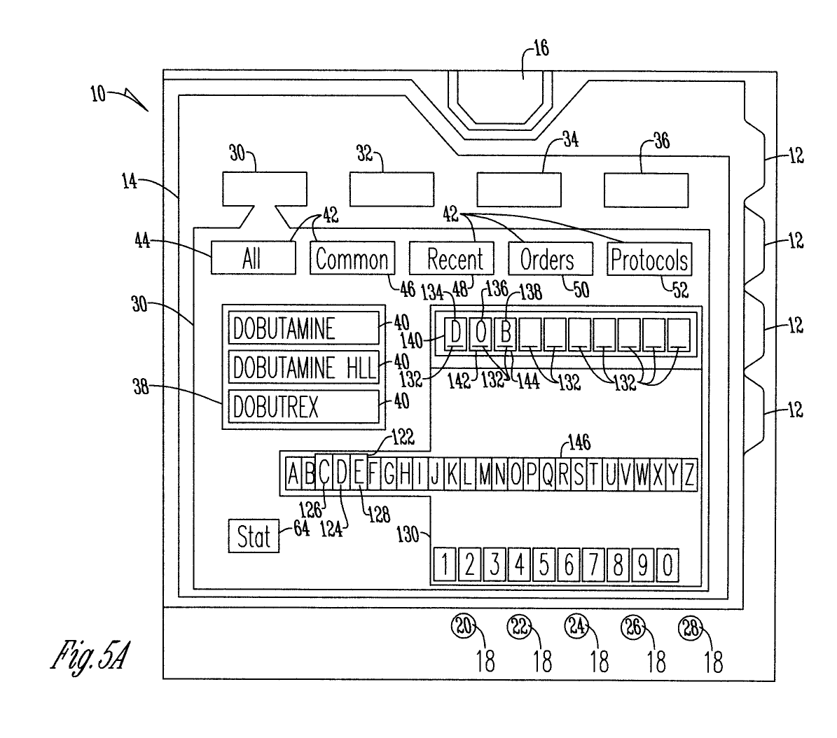

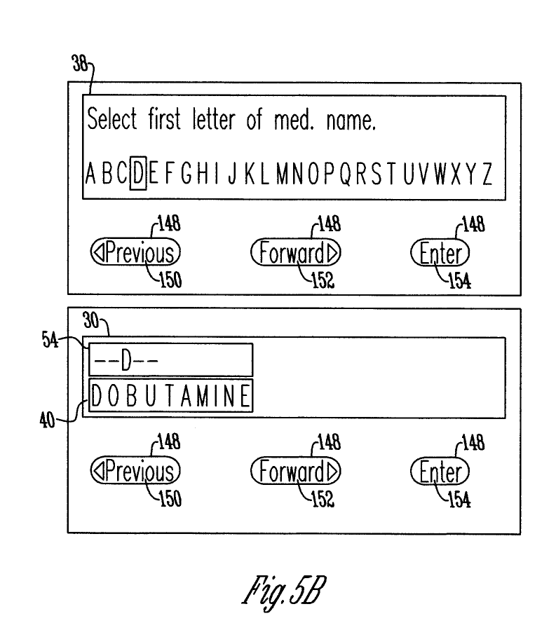

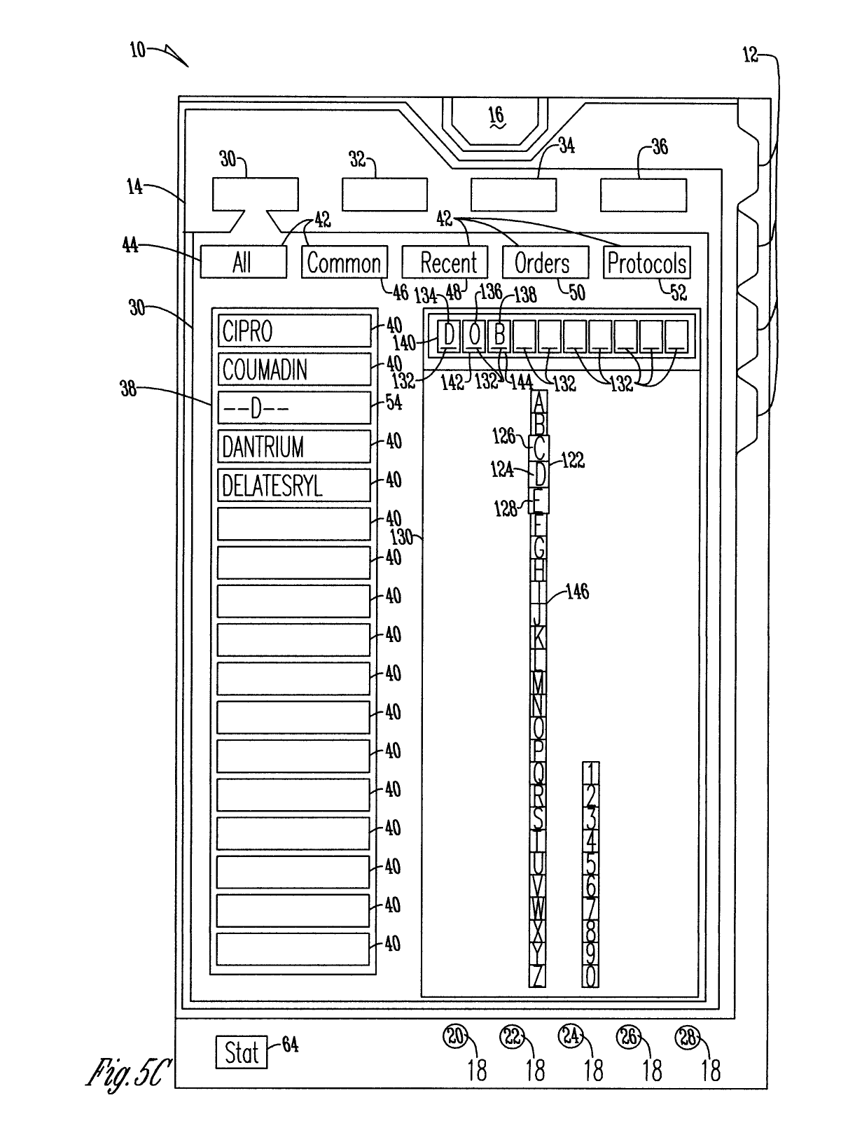

In yet another embodiment of the invention, which is illustrated in FIG. 5, the treatment input list 38 is accompanied by an alphabetical or alpha-numeric keypad 130 and a plurality of sequential entry positions 132. In order to locate a particular desired treatment input 40, a user must enter a first alpha-numeric entry 134 into a first sequential entry position 140, a second alpha-numeric entry 136, and optionally a third alpha-numeric entry 138 into a third sequential entry position 144 before any treatment inputs 40 are displayed on the treatment input list 38. Once the user has entered the first 134 and second alpha-numeric entry 136, or first 134, second 136, and third alpha-numeric entry 138, the treatment input list 38 displays the subset of all available treatment inputs 40 which have the same first and second, or first, second, and third letters input by the user into the sequential entry positions 132. The resulting subset of treatment inputs 40 displayed by the treatment input list 38 can be accessed and navigated by any means disclosed herein; e.g., by using the scroll bar 56. In yet another embodiment, which is illustrated by FIG. 5A, the alpha-numeric keypad 130 is substituted with an alpha-numeric scroll bar 146 and three position window 122 (described above), wherein the alpha-numeric scroll bar 146 is depicted as a sequential row of alphabetical and alpha-numeric positions defined by letters of the alphabet. A three position window 122 is juxtapositioned above the row of alphabetical and alpha-numeric positions to highlight the alphabetical position (e.g., a letter) of the scroll bar 146 once the user activates the scroll bar 146. Actuation of the alpha-numeric scroll bar 146 allows a user to scroll to positions defined by letters of the alphabet, wherein scrolling to an alphabetical position and actuating alpha-numeric scroll bar 146 (by any means known including but not limited to tapping or applying pressure to the scroll bar 146) inputs the alpha-numeric entries 134, 136, 138 into one of the plurality of sequential alpha-numeric entry positions 132 to display a subset of treatment inputs 40 which have the same first and second, or first, second, and third letters input by the user into the sequential entry positions 132, as described herein.

In yet another embodiment, illustrated in FIG. 5B, treatment input list 38 is displayed as a list of alpha-numeric entries, e.g., alphabetical letters and numbers, along with an invitation for a user to select the first letter/number of a medication or treatment input 40 name. Positioned below treatment input list 38 are list navigation points 148 which can be actuated by the user to select a letter corresponding to the name of a treatment input. One example of list navigation points 148 includes a previous 150, a forward 152, and an enter 154 navigation point, whereupon actuation of the previous 150 and forward 152 points allows a user to move to a particular letter of the alphabet or number to select. For example, a letter of the alphabet displayed in the treatment input list 38 could be accessed based upon the number of times the previous 150 or forward 152 points are pressed by the user. Alternatively, a user could cycle through the letters displayed by holding down the previous 150 or forward 152 points, wherein the rate of cycling is dictated by the length of time that the user holds down the previous 150 or forward 152 points. Once a desired letter is reached, the enter 154 point is selected, at which point the corresponding divider 54 with at least one treatment input 40 from the corresponding group of treatment inputs 40 is displayed by the treatment input list. At this point, the previous 150 and forward 152 navigation points are used to cycle through the subsets of treatment inputs 40 situated either above or below the divider, and once the desired treatment input 40 is located, the enter 154 navigation point is accessed to select the treatment input 40 to be administered. The list navigation points 148 of the instant embodiment can be actuated by any means described herein, or, alternatively, can be presented as traditional (e.g., plastic, rubber, etc) buttons associated with the treatment input list 38 of the treatment display 30.

In an alternate embodiment, shown in FIG. 5C, the treatment input list 38 is accompanied by the alpha-numeric scroll bar 146 depicted as a sequential row of alphabetical and alpha-numeric positions, wherein each alphabetical and alpha-numeric position corresponds to a divider 54 which is itself associated with each group of treatment inputs 40 beginning with the corresponding alphabetical and alpha-numeric character. The three position window 122 is juxtapositioned above the row of alphabetical positions to highlight the alphabetical position (e.g., a letter) of the scroll bar 146 once the user activates the scroll bar 146. The alphabetical and alpha-numeric positions of the scroll bar 146 are each linked to a corresponding divider 54 within the treatment input list such that the treatment input list 38 displays the subset of treatment inputs 40 and divider 56 that correspond to, or begin with the same letter as, the alphabetical or alpha-numeric position of the scroll bar 146.

Once the appropriate treatment input 40 has been selected, the user is taken to the program display 32 screen (FIG. 2), wherein the user is able to program or customize the manner in which the selected treatment input 40 is administered to the patient, by accessing the plurality of treatment administration inputs 66, described above. Once the user has selected the manner in which the pump is to administer the treatment input 40 in the program display 32 screen, the user is routed to the confirmation display 34 screen (FIG. 3), wherein the user can review and edit (if necessary) the selections made in the treatment display 30 screen, program display 32 screen, and options display 36 screen, begin administration of the treatment input 40 according to the programming selections made by the user by selecting start 102, cancel the program 108, or access any of the other functionalities presented in the confirmation display 34 screen, described above. Finally, the functionalities available in the options display 36 screen (FIG. 4) can be accessed from any screen in the main screen interface 14 at any point in the programming process.

Although the invention has been illustrated with respect to alphabetical lists of treatment inputs, those skilled in the art will appreciate that the principles of the invention can be readily applied to other types of lists, including but not limited to numerical, alpha-numerical, etc.

Accordingly, a digital interface has been described that, at the very least, meets the stated objectives.

What is claimed is:

1. A digital interface comprising:
a main screen having a treatment screen and a scroll bar;
the treatment screen having a list of treatment inputs;
the scroll bar having a displacement detection area, wherein the scroll bar scrolls to a divider in the list of treatment inputs in response to movement along the displacement detection area; and
wherein the treatment screen displays the list of treatment inputs beginning with the divider.

2. The digital interface of claim 1, wherein the scroll bar includes directional buttons at terminal ends of the displacement detection area which actuate the scroll bar.

3. The digital interface of claim 1, wherein the divider corresponds with a letter of the alphabet.

4. The digital interface of claim 3, wherein the treatment inputs are alphabetized, grouped according to a first letter of the treatment inputs, and separated by dividers.

5. The digital interface of claim 1, wherein the treatment screen displays the list of treatment inputs in a single column.

6. The digital interface of claim 1, wherein the scroll bar is actuated by a touch screen.

7. The digital interface of claim 1, wherein the scroll bar includes a slider that moves along the displacement detection area.

8. The digital interface of claim 1, including a three letter window, wherein the three letter window displays a current position of the scroll bar, a position preceding the current position, and a position following the current position.

9. A digital interface comprising:
a main screen having a treatment screen;
the treatment screen having a list of treatment inputs;
an alpha-numeric keypad with a plurality of sequential entry positions; and
wherein the treatment screen displays a subset of the list of treatments based upon an input of a first and at least a second letter alpha-numeric input into a first sequential entry position and at least a sequential entry position.

10. The digital interface of claim 9, wherein the treatment screen displays a subset of the list of treatment inputs which has the same first, second, and third letters input into the first sequential entry position, the sequential entry position, and a third sequential entry position.

11. A digital interface comprising:
a main screen having a treatment screen and an alpha-numeric scroll bar displaying a sequential row of alpha-numeric letters;
the treatment screen having a list of treatment inputs;
a plurality of sequential alpha-numeric entry positions wherein scrolling to an alpha-numeric letter inputs the alpha-numeric letter into an entry position; and
wherein the treatment screen displays a subset of the list of treatments based upon an input of a first and at least a second alpha-numeric letter input into a first sequential entry position and at least a second sequential entry position.

12. The digital interface of claim 11, wherein the treatment screen displays a subset of the list of treatment inputs which has the same first, second, and third letters input into the first sequential entry position, the second sequential entry position, and a third sequential entry position.

13. The digital interface of claim 11, wherein a three position window is juxtapositioned above the row of alpha-numeric letters to highlight a position of the scroll bar.

14. A digital interface comprising:
a main screen having a treatment screen and navigation inputs;
the treatment screen having a list of alpha-numeric entries displayed as a sequential row of alphabetical positions wherein each alpha-numeric entry corresponds to a divider within a list of treatment inputs; and
wherein the treatment screen displays a subset of treatment inputs beginning with the divider corresponding to the alpha-numeric entry selected by the navigation input.

15. A digital interface comprising:
a main screen having a treatment screen and an alpha-numeric scroll bar displaying a sequential row of alphabetical positions;
the treatment screen having a list of treatment inputs;
a three position window juxtapositioned above the row of alphabetical positions to highlight a position of the scroll bar;
wherein the scroll bar scrolls to a divider in the list of treatment inputs in response to movement along the sequential row of alphabetical positions; and
wherein the treatment screen displays the list of treatment inputs beginning with the divider.
